(19) United States
(12) Patent Application Publication
(10) Pub. No.: US 2025/0354524 A1
(43) Pub. Date: Nov. 20, 2025

(54) METHOD FOR CONTROLLING A TURBOMACHINE COMPRISING A GAS GENERATOR AND AN ELECTRIC MOTOR

(71) Applicant: SAFRAN AIRCRAFT ENGINES, PARIS (FR)

(72) Inventor: Seif Eddine BENATTIA, MOISSY-CRAMAYEL (FR)

(21) Appl. No.: 18/864,193

(22) PCT Filed: May 9, 2023
(86) PCT No.: PCT/EP2023/062312

§ 371 Date: Nov. 8, 2024

(30) Foreign Application Priority Data
May 11, 2022 (FR) FR2204460

(51) Int. Cl. F02C 9/48; F02C 7/36

(52) U.S. Cl. CPC F02C 9/48; F02C 7/36; F05D 2220/70; F05D 2270/052

(57) ABSTRACT

A method for controlling a turbomachine comprising including a fan positioned upstream of a gas generator. The turbomachine including an electric motor forming a torque injection device for a high-pressure rotary shaft, in which method a fuel flow setpoint for a combustion chamber and a torque setpoint (Tcons) for the electric motor (ME) are determined. The control method including the steps of determining (El) a hybridisation rate (TH) corresponding to the ratio of the power (Pe) consumed by the electric motor (ME) to the power generated by the high-pressure rotary shaft (P2), determining (E2) a torque threshold (Tseuil) from the hybridisation rate (TH), limiting (E3) the torque setpoint (Tcons) to the torque threshold (Tseuil) if the torque setpoint (Tcons) is higher than the torque threshold (Tseuil).

### TECHNICAL FIELD

The present invention relates to an aircraft turbomachine, in particular to the control of a turbomachine comprising a gas generator and an electric motor in order to provide the desired thrust as a function of the position of the aircraft pilot's control lever.

In order to improve the response time of a turbomachine during a transient phase (acceleration, deceleration, etc.), it has been proposed to equip the turbomachine with an electric motor in order to provide additional electrical torque to increase the speed of the turbomachine without leading to a pumping phenomenon. For this purpose, the patent application WO2016/020618A1 is known for an aircraft turbomachine comprising a gas generator that comprises a low-pressure compressor, a high-pressure compressor, a combustion chamber, a high-pressure turbine and a low-pressure turbine. Said low-pressure turbine is connected to said low-pressure compressor by a low-pressure rotation shaft having a low-pressure speed N1. Said high-pressure turbine is connected to said high-pressure compressor by a high-pressure rotation shaft having a high-pressure speed N2.

The turbomachine also comprises an electric motor forming a torque injection device on the high-pressure rotation shaft. The turbomachine also comprises an electronic control system which allows a fuel setpoint for the turbomachine combustion chamber and a torque setpoint for the electric motor to be determined.

As illustrated in [FIG. 1], when a pilot commands the turbomachine to accelerate, a low-pressure speed setpoint N1cons is sent to the electronic control system. To allow the low-pressure speed N1 to be increased to reach the low-pressure speed setpoint N1cons, a fuel setpoint Qcons and a torque setpoint for the electric motor are dynamically calculated by the control system to limit the acceleration time and pumping phenomena of the turbomachine.

In practice, as illustrated in [FIG. 1], the electrical power Pe consumed by the electric motor is at its maximum after approximately 5s for a high-pressure speed N2 of the order of 20,000 rpm (instant t1). Referring to FIG. 2, at this speed, the power P2 developed by the high-pressure rotation shaft is much greater than the electrical power Pe consumed by the electric motor. Thus, for certain high-pressure N2 speeds, the electric motor's input remains low but it is always activated, which increases the consumption of the electrical source to which the electric motor is connected (battery, etc.).

An immediate solution to this problem would be to stop the electric motor when the high-pressure speed N2 exceeds a predetermined threshold. Such a solution is not feasible, as it may depend on the operating conditions of the turbomachine, the type of gas generator and the type of electric motor. An abrupt switch-off of the electric motor would also lead to control difficulties (dragging, fuel regulation, etc.).

The invention aims to eliminate at least some of these disadvantages.

The prior art includes the patent applications FR3087491A1 and US2020/27063A1, which present methods for controlling an electric motor for an aircraft.

### Presentation of the Invention

The invention relates to a method for controlling a turbomachine comprising a fan positioned upstream of a gas generator and delimiting a primary flux and a secondary flux, said gas generator being traversed by the primary flux and comprising a low-pressure compressor, a high-pressure compressor, a combustion chamber, a high-pressure turbine and a low-pressure turbine, said low-pressure turbine being connected to said low-pressure compressor by a low-pressure rotation shaft and said high-pressure turbine being connected to said high-pressure compressor by a high-pressure rotation shaft, the turbomachine comprising an electric motor forming a torque injection device on the high-pressure rotation shaft, method in which a fuel flow rate setpoint in the combustion chamber and a torque setpoint supplied to the electric motor are defined, the control method comprising steps consisting of:
Determining a hybridization rate corresponding to the power consumed by the electric motor in relation to the power generated by the high-pressure rotation shaft.
Determining a torque threshold from the hybridization rate and
Limiting the torque setpoint to the torque threshold if the torque setpoint is greater than the torque threshold.

Thanks to the invention, the torque setpoint can be saturated at a torque threshold determined on the basis of the hybridization rate, i.e. the proportion of electrical energy consumed in driving the high-pressure rotation shaft. In this way, the electricity consumption can be advantageously reduced when this energy is not important in the drive. The size and bulk of electrical sources can be reduced, which is environmentally advantageous for aircraft. Moreover, the addition of a torque threshold in accordance with the invention does not affect the general control of the turbomachine for determining fuel and torque setpoints.

Preferably, the torque threshold is determined according to the following law:

Tseuil=Tmax*A wherein.

A is a duty cycle determined from the hybridization rate TH and
Tmax is a maximum torque setpoint for said electric motor ME.

The torque threshold is thus determined in relation to the maximum capacity of the electric motor, allowing dynamic adjustment.

Preferably, the duty cycle is determined from the hybridization rate according to an increasing law. The use of an increasing law means that the electric motor is favoured as the degree of hybridization increases and, conversely, its use is limited when hybridization is low.

Preferably, the law is strictly increasing up to a predetermined hybridization threshold. This optimises the use of the electric motor.

According to one aspect of the invention, the law is linear up to a predetermined hybridization threshold. The use of a linear law enables proportional processing, which significantly limits the torque setpoint.

According to another aspect of the invention, the law is exponential up to a predetermined hybridization threshold. An exponential law is used to limit the torque significantly when hybridization is low. Such an exponential law enables high control performance to be maintained, limiting overshoot or drag, compared with a linear law.

Preferably, the duty cycle is equal to 1 above a predetermined hybridization threshold. This means that no saturation occurs when the hybridization rate is above the threshold. Preferably, the predetermined hybridization threshold is greater than 50%, and preferably less than 70%. The electric motor remains the preferred choice for high rates of hybridization.

The invention also relates to a computer program comprising instructions for carrying out the steps of the method for controlling as previously presented when said program is executed by a computer.

The invention also relates to an electronic control system for a turbomachine comprising a memory including instructions of a computer program as previously presented.

The invention also relates to a turbomachine comprising an electronic system as described above.

### PRESENTATION OF THE FIGURES

The invention will be better understood on reading the following description, given by way of example, with reference to the following figures, given by way of non-limiting examples, wherein identical references are given to similar objects.

FIG. 1 is a schematic representation according to the prior art of the evolution of the low-pressure speed, the high-pressure speed, the fuel setpoint and the electrical consumption of the electric motor during acceleration of the turbomachine.

FIG. 2 is a schematic representation of the evolution of the electrical power consumed and the power developed by the high-pressure rotation shaft.

FIG. 3 is a schematic representation of a turbomachine according to the invention,

FIG. 4 is a schematic representation of the steps in a method for controlling a turbomachine according to an example of implementation in accordance with the invention.

FIG. 5 is a schematic representation of the evolution of the electrical power consumed, the power developed by the high-pressure rotation shaft and the hybridization rate.

FIG. 6 is a schematic representation of a linear law for determining a duty cycle in order to determine a torque threshold.

FIG. 7 is a schematic representation of the evolution of the low-pressure speed, the high-pressure speed, the fuel setpoint and the electrical consumption of the electric motor during an acceleration of the turbomachine over 9 seconds with a linear law according to [FIG. 6].

FIG. 8 is a schematic representation of the evolution of the low-pressure speed, the high-pressure speed, the fuel setpoint and the electrical consumption of the electric motor during an acceleration of the turbomachine over 4.5 seconds with a linear law according to [FIG. 6].

FIG. 9 is a schematic representation of an exponential law for determining a duty cycle in order to determine a torque threshold.

FIG. 10 is a schematic representation of the evolution of the low-pressure speed, the high-pressure speed, the fuel setpoint and the electric motor power consumption during an acceleration of the turbomachine over 4.5 seconds with an exponential law according to [FIG. 9],

FIG. 11 is a schematic representation of a system for controlling a turbomachine.

It should be noted that the figures set out the invention in detail in order to implement the invention, said figures of course being able to be used to better define the invention if necessary.

### DETAILED DESCRIPTION OF THE INVENTION

With reference to [FIG. 3], a schematic representation of a turbomachine 100 of the dual-flow and two-spool turbojet engine for aircraft is shown. In a known way, the turbomachine 100 comprises, from upstream to downstream in the direction of gas flow, a fan 110, a low-pressure compressor 111, a high-pressure compressor 112, a combustion chamber 113 which receives a fuel flow rate setpoint Qcons, a high-pressure turbine 114, a low-pressure turbine 115 and a primary exhaust nozzle 116. The fan 110, the low-pressure compressor (or LP) 111 and the low-pressure turbine 115 are connected by a low-pressure rotation shaft 121 and together form a low-pressure body. The low-pressure rotation shaft 121 has a low-pressure speed N1.

The high-pressure compressor (or HP) 112 and the high-pressure turbine 114 are connected by a high-pressure rotation shaft 122 and together form a high-pressure body. The high-pressure rotation shaft 122 has a high-pressure speed N2.

The fan 110, which is driven by the low-pressure shaft 121, compresses the ingested air. This air is divided downstream of the fan 110 between a secondary air flux which is directed directly towards a secondary nozzle (not shown) through which it is ejected to contribute to the thrust provided by the turbomachine 100, and a so-called primary flux which enters the gas generator, formed by the low-pressure body and the high-pressure body, and is then ejected into the primary nozzle 116. In a known way, to modify the speed of the turbomachine 100, the pilot of the aircraft modifies the position of a control lever which makes it possible to modify the fuel flow rate setpoint Qcons in the combustion chamber 113.

With reference to [FIG. 3], the turbomachine 100 also comprises an electric motor ME configured to supply additional torque to the high-pressure rotation shaft 122. The operation of the turbomachine 100 comprises a control system 300 configured to obtain signals representing operating parameters PAR of the turbomachine 100 to determine a fuel flow rate setpoint Qcons and a torque setpoint Tcons for the electric motor ME. The operating parameters PAR of the turbomachine 100 may include, in particular, current measurements of the low-pressure speed N1, the high-pressure speed N2, the nozzle outlet temperature, the electrical power Pe consumed by the electric motor ME, the power generated by the high-pressure rotation shaft P2, pressure measurements, and so on.

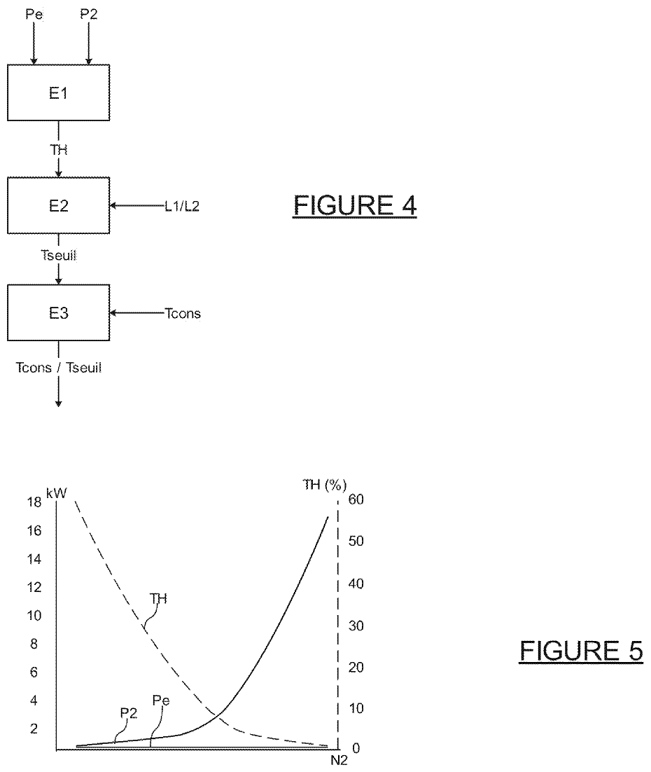

With reference to [FIG. 4], the control system 300 is configured to implement a control method comprising the steps of:
Determining E1 a hybridization rate TH corresponding to the power generated Pe by the electric motor ME in relation to the power generated by the high-pressure rotation shaft P2.
Determining E2 a torque threshold Tseuil from the hybridization rate TH,
Limiting E3 the torque setpoint Tcons to the torque threshold Tseuil if the torque setpoint Tcons is greater than the torque threshold Tseuil.

Thanks to the invention, the hybridization rate TH is taken into account to use the aircraft's electrical resources sparingly. The use of the electric motor ME is advantageously reduced when the degree of hybridization TH is low.

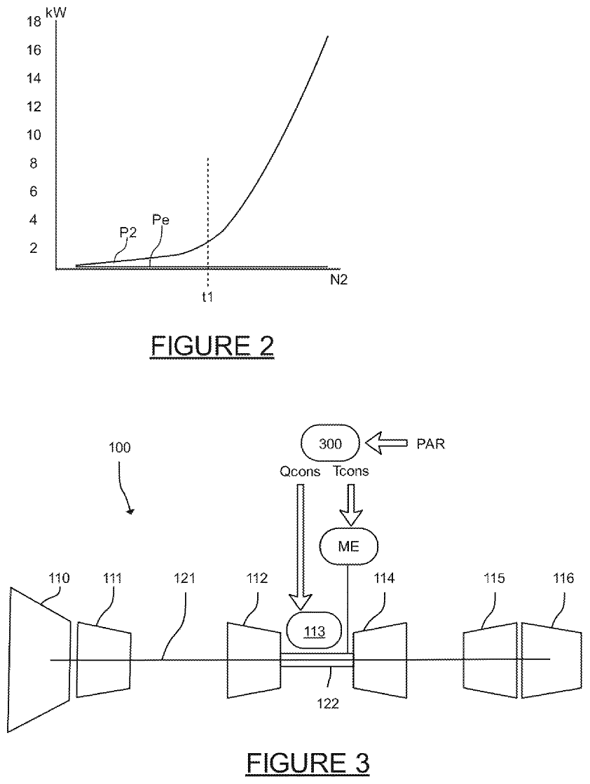

As illustrated in [FIG. 5] (which completes the [FIG. 2] previously presented), the hybridization rate TH drops significantly, in particular exponentially, when the turbomachine 100 is accelerated. Limiting the torque setpoint Tcons as a function of the degree of hybridization TH automatically reduces power consumption. This reduction is automatic and can be transposed to different turbomachines, regardless of a particular rotation speed.

The degree of hybridization TH is determined on the basis of operating parameters PAR of the turbomachine 100, in particular the power consumed Pe by the electric motor ME and the power generated P2 by the high-pressure rotation shaft 122. Determining the TH hybridization rate is quick and easy.

Preferably, the torque threshold Tseuil is determined according to the following law:

Tseuil=Tmax*A where:
A is a duty cycle determined from the TH hybridization rate and
Tmax is a maximum torque setpoint for said electric motor ME.

As shown in [FIG. 4], the duty cycle A is determined from the hybridization rate TH according to an increasing law L1, L2. So the higher the hybridization rate TH, the higher the duty cycle A. The electrical power Pe is thus consumed as a priority when it is significant in driving the high-pressure drive shaft 122 in rotation. This optimises the consumption of electric batteries.

The invention will be presented for a first linear law L1 and a second exponential law L2, but it goes without saying that the invention applies to other increasing laws.

As will be shown below, the duty cycle A is equal to 1 above a predetermined hybridization threshold STH in order to make maximum use of the electric motor ME when the hybridization rate TH is high. Such a predetermined hybridization threshold STH gives preference to the electric motor ME. Preferably, the predetermined hybridization threshold STH is greater than 50% so that the electrical input remains significant. This is preferably less than 70% to ensure maximum use of the electric motor ME at high hybridization rates TH. A predetermined hybridization threshold STH of 60% is then used as an example.

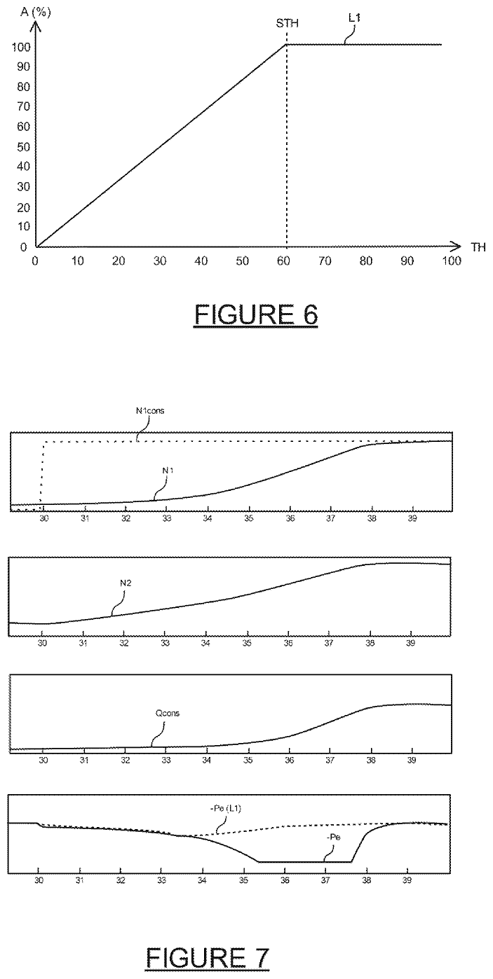

In a first example, with reference to [FIG. 6], the first law L1 is linear up to a predetermined hybridization threshold STH, in this case 60%, and then constant.

The duty cycle A increases between 0 and 1 for a hybridization rate TH of between 0% and 60%, then stagnates at 1. This allows us to determine a torque threshold Tseuil which is also increasing for the electric motor ME.

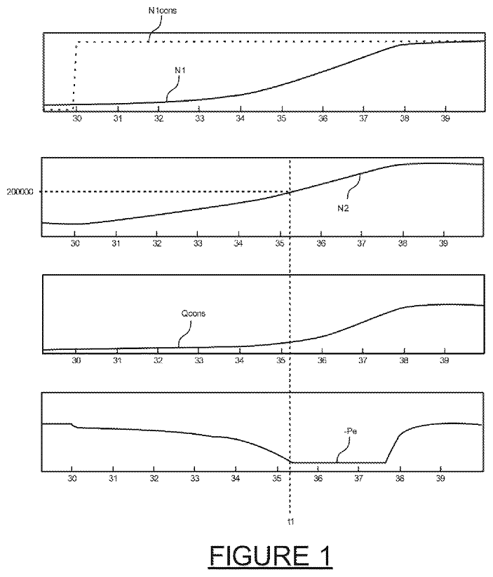

With reference to [FIG. 7], a schematic diagram shows the evolution of low-pressure speed N1, the high-pressure speed N2, the fuel setpoint Qcons and the electrical consumption of the electric motor Pe during an acceleration of the turbomachine over a time span of 9 seconds. A continuous line shows the low-pressure speed N1, the high-pressure speed N2, the fuel setpoint Qcons and the electrical consumption of the electric motor Pe according to the prior art (see [FIG. 1]). In [FIG. 7], a dashed line represents the electric motor power consumption Pe (L1), which is limited by the torque threshold Tseuil as a function of the first linear law L1.

It appears that the power consumption Pe is more linear, which limits wear and tear on the electrical machine ME. In addition, there is no over-consumption of electricity as in the prior art, which preserves the electrical resources on board the aircraft, such as batteries. Electric batteries of lower capacity can therefore be used.

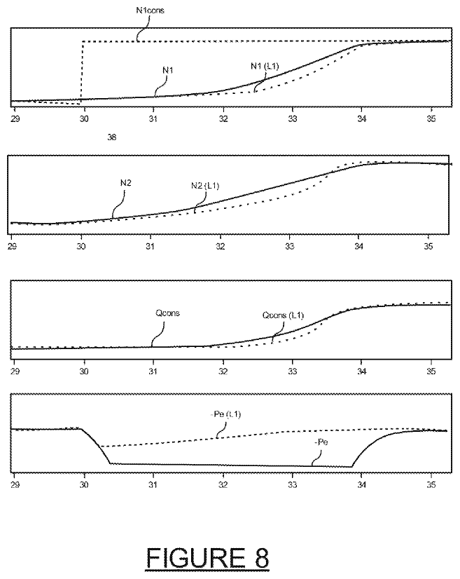

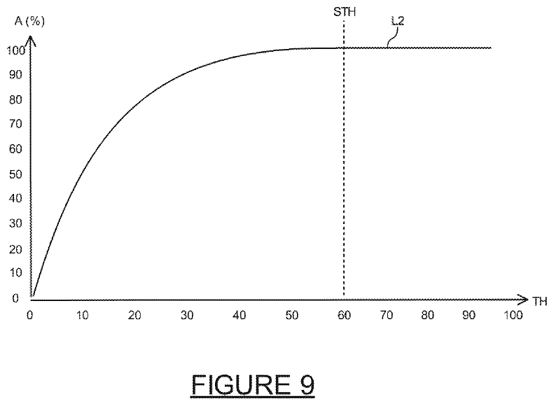

With reference to [FIG. 8], the evolution of the low-pressure speed N1, the high-pressure speed N2, the fuel setpoint Qcons and the electrical consumption of the electric motor Pe during acceleration of the turbomachine over a time range of 4.5 seconds is shown schematically. For an acceleration over a reduced time range, the parameters of the turbomachine 100 are more impacted.

The solid line shows the values without the invention and the dashed line shows the values taking account of the torque threshold Tseuil as a function of the first linear law L1. There is an increase in the fuel setpoint Qcons (L1) (between t=29s and t=30.3s) with a gradual increase in the power consumption Pe. At time t=30.3s. the power consumption Pe falls due to the activation of the torque threshold Tseuil. The result is a slight drag on the high pressure speed N2 (L1), which cannot keep up with the set high pressure speed N2cons. The high pressure regime N2 (L1) was also exceeded at the end of acceleration at time t=33.6s.

To improve control performance while optimising power injection on the high-pressure rotation shaft 122, an L2 exponential law is recommended.

In this second example, with reference to [FIG. 9], the second law L2 is exponential up to a predetermined hybridization threshold STH, in this case 60%, and then constant.

The duty cycle A increases between 0 and 1 for a hybridization rate TH of between 0% and 60%, then stagnates at 1. This allows us to determine a torque threshold Tseuil which is also increasing for the electric motor ME.

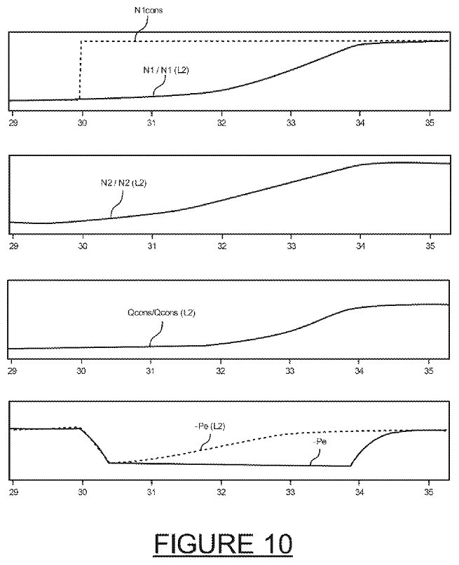

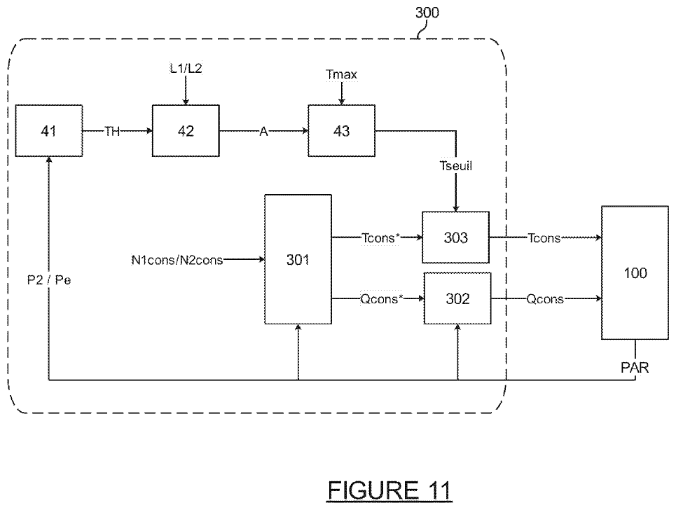

With reference to [FIG. 10], the evolution of the low-pressure speed N1, the high-pressure speed N2, the fuel setpoint Qcons and the electrical consumption of the electric motor Pe during acceleration of the turbomachine 100 over a time range of 4.5 seconds is shown schematically. The dashed line in [FIG. 10] shows the electrical consumption of the electric motor Pe (L2), which is limited by the torque threshold Tseuil as a function of the second exponential law L2. The other parameters are only slightly affected by the second exponential law L2 (no dragging or overshooting). Regulation remains optimal.

As a result, Pe power consumption is more linear, which reduces wear and tear on the electrical machine ME. In addition, there is no over-consumption of electricity as in the prior art, which preserves the electrical resources on board the aircraft, such as batteries. The second exponential law L2 offers advantages for both normal accelerations (9 seconds) and rapid accelerations (4, 5 seconds). Control performance is maintained in all circumstances.

The invention also relates to a computer program comprising instructions for carrying out the steps of the control method when said program is executed by a computer. The invention also relates to the electronic control system 300 for the turbomachine 100 comprising a memory including computer program instructions.

An embodiment of an electronic control system 300 according to the invention is shown in [FIG. 11]. In this figure, the electronic control system 300 sends a torque setpoint Tcons and a fuel setpoint Qcons to the turbomachine 100, in particular to the electric motor ME and the combustion chamber 113. The turbomachine 100 transmits PAR operating parameters to the control system 300 as described above.

In this example, the control system 300 comprises a multivariable correction module 301 for determining gross torque setpoints Tcons* and fuel setpoints Qcons* from a speed setpoint (speed N1 or N2) and operating parameters PAR.

The control system 300 also comprises a fuel limiting module 302 which allows thermal limits (outlet temperature, etc.) to be imposed on the gross fuel setpoint Qcons* in order to determine the fuel setpoint Qcons to be supplied to the combustion chamber 113.

The control system 300 comprises:
a module 41 for determining the degree of hybridization TH on the basis of operating parameters PAR, in particular the power consumed Pe by the electric motor ME in relation to the power generated by the high-pressure body P2.
a module 42 for determining the duty cycle A from the hybridization rate TH on the basis of a law L1, L2,
a module 43 for determining the torque threshold Tseuil from the duty cycle A and the predetermined maximum torque Tmax,
a torque-limiting module 303 which allows torque limits to be imposed on the raw torque setpoint Tcons* in order to determine the torque setpoint Tcons to be supplied to the electric motor ME.

In this way, the torque setpoint Tcons will be limited to the torque threshold Tseuil if the torque setpoint Tcons is greater than the torque threshold Tseuil. The torque setpoint Tcons can therefore be saturated.

Thanks to the invention, the torque setpoint Tcons is determined to preserve the aircraft's electrical resources. Electrical power is only consumed when it is significant in the hybridization of resources consumed. Preserving electrical resources allows batteries to last longer, while reducing their cost and size.

1. A method for controlling a turbomachine (100) comprising a fan (110) positioned upstream of a gas generator and delimiting a primary flux and a secondary flux, said gas generator being traversed by the primary flux and comprising a low-pressure compressor (111), a high-pressure compressor (112), a combustion chamber (113), a high-pressure turbine (114) and a low-pressure turbine (115), said low-pressure turbine (115) being connected to said low-pressure compressor by a low-pressure rotation shaft (121) and said high-pressure turbine (114) being connected to said high-pressure compressor (112) by a high-pressure rotation shaft (122), the turbomachine (100) comprising an electric motor (ME) forming a torque injection device on the high-pressure rotation shaft (122), a method in which a fuel flow rate setpoint (Qcons) in the combustion chamber (113) and a torque setpoint (Tcons) supplied to the electric motor (ME) are defined, the control method comprising the steps of:
determining (E1) a hybridization rate (TH) corresponding to a power consumed (Pe) by the electric motor (ME) in relation to a power generated by the high-pressure rotation shaft (122),
determining (E2) a torque threshold (Tseuil) from the hybridization rate (TH), and
limiting (E3) the torque setpoint (Tcons) to the torque threshold (Tseuil) if the torque setpoint (Tcons) is greater than the torque threshold (Tseuil).

2. The control method according to claim 1, wherein the torque threshold (Tseuil) is determined according to the following law:
Tseuil=Tmax*A where
A is a duty cycle determined from the hybridization rate (TH), and
Tmax is a maximum torque setpoint for said electric motor (ME).

3. The control method according to claim 2, wherein the duty cycle (A) is determined from the hybridization rate (TH) according to an increasing law (L1, L2).

4. The control method according to claim 2, wherein the duty cycle (A) is equal to 1 above a predetermined hybridization threshold (STH).

5. The control method according to claim 3, wherein the law (L1) is linear up to a predetermined hybridization threshold (STH).

6. The control method according to claim 3, wherein the law (L1) is exponential up to a predetermined hybridization threshold (STH).

7. The control method according to claim 4, wherein the predetermined hybridization threshold (STH) is greater than 50%.

8. A computer program comprising instructions for executing the steps of the control method according to claim 1 when said program is executed by a computer of the (100).

9. An electronic control system (300) for the turbomachine (100) comprising a memory including instructions of the computer program according to claim 8.

10. A turbomachine (100) comprising an electronic control system (300) according to claim 9.

11. The control method according to claim 7, wherein the predetermined hybridization threshold (STH) is less than 70%.
